(19) United States
(12) Patent Application Publication
(10) Pub. No.: US 2014/0000860 A1
(43) Pub. Date: Jan. 2, 2014

(54) COOLING SYSTEM FOR VEHICLE

(71) Applicants: Jun Nishizawa, Miyoshi-shi (JP); Nozomi Nagasaki, Toyota-shi (JP)

(72) Inventors: Jun Nishizawa, Miyoshi-shi (JP); Nozomi Nagasaki, Toyota-shi (JP)

(73) Assignee: TOYOTA JIDOSHA KABUSHIKI KAISHA, Toyota-shi, Aichi-ken (JP)

(21) Appl. No.: 13/983,893

(22) PCT Filed: Mar. 8, 2011
(86) PCT No.: PCT/JP2011/055324

§ 371 Date: Aug. 6, 2013

(51) Int. Cl. B60H 1/32

(52) U.S. Cl. CPC B60H 1/32
USPC 165/202

(57) ABSTRACT

A cooling system for a vehicle includes a flow channel circulating a liquid medium cooling a drive device of the vehicle, a plurality of temperature sensors provided at different positions on the flow channel, a heating element provided on the flow channel and cooled by the liquid medium, and a control device controlling heat generation from the heating element. The control device changes a heat generating state of the heating element, and estimates a flow rate of the liquid medium flowing through the flow channel based on a time lag taken for detecting a temperature change caused by changing the heat generating state by the plurality of temperature sensors. Preferably, the drive device includes a motor, and a power control unit for driving the motor, and the heating element is a power control element in the power control unit.

### TECHNICAL FIELD

The present invention relates to a cooling system for a vehicle, and in particular to a cooling system for a vehicle capable of detecting a flow rate of a cooling liquid medium of a cooling system.

### BACKGROUND ART

As an exemplary technique for controlling a rotation speed of a circulation water pump in a water-cooling type inverter device having frequent load changes, an inverter device is described in Japanese Patent Laying-Open No. 2004-332988 (PTD 1). In the inverter device, a circulation pump control device detects the temperature of an inverter module at regular time intervals using a temperature detector, and controls a rotation speed of a circulation water pump so as to change the amount of cooling water to be capable of cooling generated heat in an amount corresponding to a temperature difference from a temperature detected immediately previously.

### CITATION LIST

### Patent Document

PTD 1: Japanese Patent Laying-Open No. 2004-332988
PTD 2: Japanese Patent Laying-Open No. 2006-156711
PTD 3: Japanese Patent Laying-Open No. 2008-256313
PTD 4: Japanese Patent Laying-Open No. 2009-171702
PTD 5: Japanese Patent Laying-Open No. 2008-253098

### SUMMARY OF INVENTION

### Technical Problem

In Japanese Patent Laying-Open No. 2004-332988, a rotation number of the pump is controlled based on a difference between previous and present measured temperature values to keep the temperature constant. However, in a case where an abnormality or a failure has occurred in the pump or a cooling path, even if the difference between previous and present temperatures is measured, the temperature rises and the pump rotation speed is increased more and more. In such a case, it is effective to detect an abnormality quickly.

Although it is desirable to detect a flow rate of cooling water in order to detect an abnormality, a flow rate sensor is expensive, and causes an increase in water-flow resistance and produces loss.

One object of the present invention is to provide a cooling system for a vehicle capable of estimating a flow rate of a cooling liquid medium without using a flow rate sensor.

### Solution to Problem

In summary, the present invention is directed to a cooling system for a vehicle, including a flow channel circulating a liquid medium cooling a drive device of the vehicle, a plurality of temperature sensors provided at different positions on the flow channel, a heating element provided on the flow channel and cooled by the liquid medium, and a control device controlling heat generation from the heating element. The control device changes a heat generating state of the heating element, and estimates a flow rate of the liquid medium flowing through the flow channel based on a time lag taken for detecting a temperature change caused by changing the heat generating state by the plurality of temperature sensors.

Preferably, the drive device includes a motor, and a power control unit for driving the motor. The heating element is a power control element in the power control unit.

More preferably, in a case where the vehicle is stopped, the control device changes a drive state of the power control element to change the heat generating state when the control device estimates the flow rate, such that no drive torque is generated at wheels.

Further preferably, the vehicle includes a power storage device supplying electric power to the motor. The power control unit includes a voltage converter converting a voltage of the power storage device, and an inverter supplying and receiving electric power to and from the power storage device via the voltage converter, and driving the motor. The control device changes a heat generating amount of the power control element by changing a carrier frequency of the voltage converter.

Further preferably, the vehicle includes an internal combustion engine, a generator rotated by the internal combustion engine, and a power storage device charged by the generator and supplying electric power to the motor. The power control unit includes a voltage converter converting a voltage of the power storage device, and an inverter receiving electric power generated by the generator, and supplying and receiving electric power to and from the power storage device via the voltage converter. The control device changes a heat generating amount of the power control element by causing the generator to generate electric power and causing the power storage device to be charged.

More preferably, in a case where the vehicle is running, the control device estimates the flow rate when a drive state of the power control element is changed and a change in the heat generating state occurs.

More preferably, the cooling system for the vehicle further includes a pump provided on the flow channel for circulating the liquid medium. The control device controls driving of the pump based on the estimated flow rate of the liquid medium.

More preferably, the cooling system for the vehicle further includes a pump provided on the flow channel for circulating the liquid medium, and a water flow channel. The control device identifies whether the pump or the water flow channel has a failure, based on a rotation speed of the pump and the estimated flow rate of the liquid medium.

### Advantageous Effects of Invention

According to the present invention, even in an existing configuration, the flow rate of cooling water can be estimated by providing temperature sensors at a plurality of locations. When the flow rate of the cooling water can be estimated, for example, an abnormality in a cooling mechanism can be distinctively detected more specifically, and thus a location to be checked at the time of repair is limited and working efficiency is improved.

### BRIEF DESCRIPTION OF DRAWINGS

FIG. 1 is a circuit diagram showing a configuration of a vehicle 100 mounted with a cooling system for the vehicle.

FIG. 2 is a diagram for illustrating a principle of flow rate estimation in the present embodiment.

FIG. 3 is an operation waveform diagram for illustrating control related to the flow rate estimation.

FIG. 4 is a flowchart for illustrating flow rate estimation processing executed in Embodiment 1.

FIG. 5 is a circuit diagram showing a configuration of a vehicle 200 mounted with a cooling system for the vehicle.

FIG. 6 is a flowchart for illustrating flow rate estimation processing executed in Embodiment 2.

### DESCRIPTION OF EMBODIMENTS

Hereinafter, embodiments of the present invention will be described in detail with reference to the drawings. In the drawings, the same or corresponding components are denoted by the same reference characters, and a description thereof will not be repeated.

### Embodiment 1

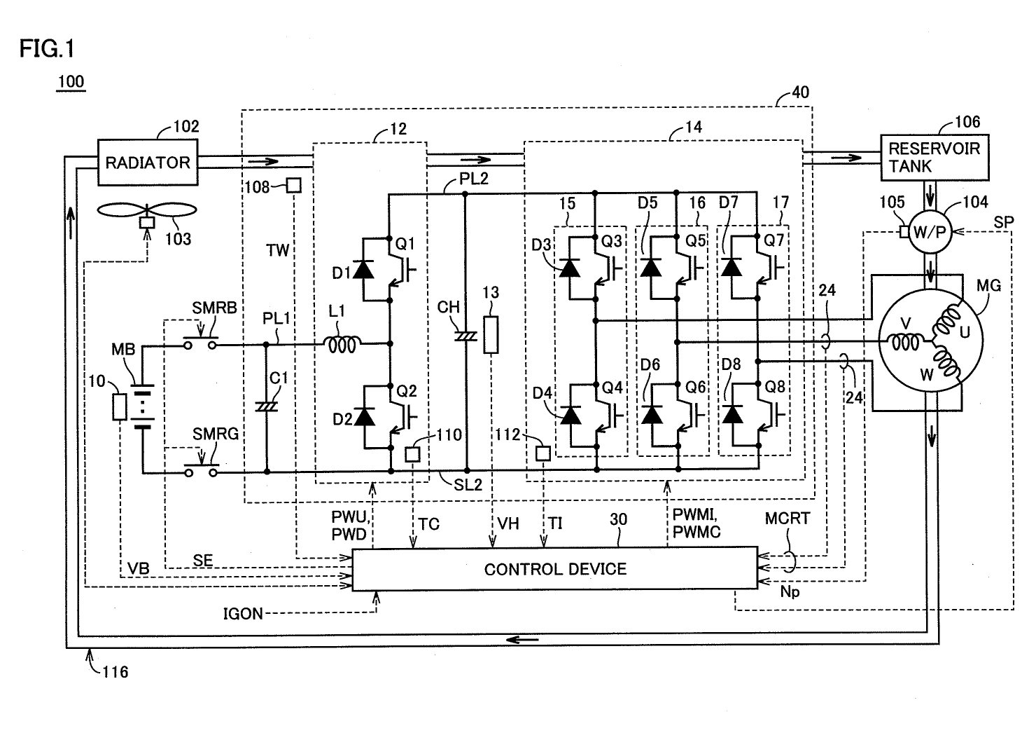

FIG. 1 is a circuit diagram showing a configuration of a vehicle 100 mounted with a cooling system for the vehicle. Although Embodiment 1 provides an example where vehicle 100 is an electric vehicle, the present invention is also applicable to a hybrid vehicle which also adopts an internal combustion engine and a fuel cell vehicle, other than an electric vehicle, as long as the vehicle is mounted with a cooling system.

Referring to FIG. 1, vehicle 100 includes a battery MB which is a power storage device, a voltage sensor 10, a power control unit (PCU) 40, a motor generator MG, and a control device 30. PCU 40 includes a voltage converter 12, smoothing capacitors C1, CH, a voltage sensor 13, and an inverter 14. Vehicle 100 further includes a positive bus PL2 for supplying electric power to inverter 14 which drives motor generator MG.

Smoothing capacitor C1 is connected between a positive bus PL1 and a negative bus SL2. Voltage converter 12 boosts a voltage between the terminals of smoothing capacitor C1. Smoothing capacitor CH smoothes the voltage boosted by voltage converter 12. Voltage sensor 13 detects a voltage VH between the terminals of smoothing capacitor CH and outputs detected voltage VH to control device 30.

Vehicle 100 further includes a system main relay SMRB connected between the positive terminal of battery MB and positive bus PL1, and a system main relay SMRG connected between the negative terminal of battery MB (a negative bus SL1) and a node N2.

The conductive/nonconductive state of system main relays SMRB, SMRG is controlled in response to a control signal SE provided from control device 30. Voltage sensor 10 measures a voltage VB between the terminals of battery MB. A current sensor (not shown) which detects a current IB flowing in battery MB is provided to monitor the state of charge of battery MB together with voltage sensor 10.

As battery MB, for example, a secondary battery such as lead-acid battery, nickel-metal hydride battery, or lithium ion battery, or a large-capacity capacitor such as electric double-layer capacitor can be used. Negative bus SL2 extends through voltage converter 12 toward inverter 14.

Voltage converter 12 is a voltage conversion device provided between battery MB and positive bus PL2 for performing voltage conversion. Voltage converter 12 includes a reactor L1 having one end connected to positive bus PL1, IGBT elements Q1, Q2 connected in series between positive bus PL2 and negative bus SL2, and diodes D1, D2 connected in parallel with IGBT elements Q1, Q2, respectively.

Reactor L1 has the other end connected to the emitter of IGBT element Q1 and the collector of IGBT element Q2. Diode D1 has its cathode connected to the collector of IGBT element Q1, and has its anode connected to the emitter of IGBT element Q1. Diode D2 has its cathode connected to the collector of IGBT element Q2, and has its anode connected to the emitter of IGBT element Q2.

Inverter 14 is connected to positive bus PL2 and negative bus SL2. Inverter 14 converts a direct current (DC) voltage output from voltage converter 12 into a three-phase alternating current (AC) voltage and outputs it to motor generator MG which drives wheels 2. Further, when regenerative braking is performed, inverter 14 returns electric power generated by motor generator MG to voltage converter 12. At this time, voltage converter 12 is controlled by control device 30 to operate as a buck circuit.

Inverter 14 includes a U phase arm 15, a V phase arm 16, and a W phase arm 17. U phase arm 15, V phase arm 16, and W phase arm 17 are connected in parallel between positive bus PL2 and negative bus SL2.

U phase arm 15 includes IGBT elements Q3, Q4 connected in series between positive bus PL2 and negative bus SL2, and diodes D3, D4 connected in parallel with IGBT elements Q3, Q4, respectively. Diode D3 has its cathode connected to the collector of IGBT element Q3, and has its anode connected to the emitter of IGBT element Q3. Diode D4 has its cathode connected to the collector of IGBT element Q4, and has its anode connected to the emitter of IGBT element Q4.

V phase arm 16 includes IGBT elements Q5, Q6 connected in series between positive bus PL2 and negative bus SL2, and diodes D5, D6 connected in parallel with IGBT elements Q5, Q6, respectively. Diode D5 has its cathode connected to the collector of IGBT element Q5, and has its anode connected to the emitter of IGBT element Q5. Diode D6 has its cathode connected to the collector of IGBT element Q6, and has its anode connected to the emitter of IGBT element Q6.

W phase arm 17 includes IGBT elements Q7, Q8 connected in series between positive bus PL2 and negative bus SL2, and diodes D7, D8 connected in parallel with IGBT elements Q7, Q8, respectively. Diode D7 has its cathode connected to the collector of IGBT element Q7, and has its anode connected to the emitter of IGBT element Q7. Diode D8 has its cathode connected to the collector of IGBT element Q8, and has its anode connected to the emitter of IGBT element Q8.

Motor generator MG is a three-phase permanent-magnet synchronous motor, and three stator coils of the U, V, and W phases have respective ends connected together to a neutral point. The other end of the U phase coil is connected to a line drawn from a connection node of IGBT elements Q3, Q4. The other end of the V phase coil is connected to a line drawn from a connection node of IGBT elements Q5, Q6. The other end of the W phase coil is connected to a line drawn from a connection node of IGBT elements Q7, Q8.

A current sensor 24 detects a current flowing in motor generator MG as a motor current value MCRT, and outputs motor current value MCRT to control device 30.

Control device 30 receives a torque command value and a rotation speed of motor generator MG, respective values of current IB and voltages VB, VH, motor current value MCRT, and an activation signal IGON. Control device 30 outputs, to voltage converter 12, a control signal PWU for giving an instruction to boost the voltage, a control signal PWD for giving an instruction to buck the voltage, and a shutdown signal for giving an instruction to inhibit operation.

Further, control device 30 outputs, to inverter 14, a control signal PWMI for giving a drive instruction to convert the DC voltage which is an output from voltage converter 12 into an AC voltage for driving motor generator MG, and a control signal PWMC for giving a regeneration instruction to convert an AC voltage generated by motor generator MG into a DC voltage and return the DC voltage to voltage converter 12.

[Description of Cooling Mechanism in Embodiment 1]

Referring again to FIG. 1, vehicle 100 includes, as a cooling mechanism for cooling PCU 40 and motor generator MG, a radiator 102, a reservoir tank 106, and a water pump 104.

Radiator 102, PCU 40, reservoir tank 106, water pump 104, and motor generator MG are annularly connected in series by a water flow channel 116.

Water pump 104 is a pump for circulating cooling water such as an antifreeze liquid, and circulates the cooling water in a direction indicated by arrows shown in the drawing. Radiator 102 receives, from the water flow channel, the cooling water having cooled voltage converter 12 and inverter 14 in PCU 40, and cools the received cooling water by means of a radiator fan 103.

In the vicinity of a cooling water inlet of PCU 40, a temperature sensor 108 which measures a cooling water temperature is provided. A cooling water temperature TW is transmitted from temperature sensor 108 to control device 30. Further, in PCU 40, a temperature sensor 110 which detects a temperature TC of voltage converter 12 and a temperature sensor 112 which detects a temperature TI of inverter 14 are provided. As temperature sensors 110, 112 each, a temperature detection element or the like embedded in an intelligent power module is used.

Control device 30 generates a signal SP for driving water pump 104 based on temperature TC from temperature sensor 110 and temperature TI from temperature sensor 112, and outputs generated signal SP to water pump 104.

In the configuration shown in FIG. 1, a plurality of temperature sensors 108, 110, 112 are used to detect a flow rate of the cooling water which has not been detected conventionally. While a failure could have conventionally been identified merely as an abnormality in the cooling mechanism, detection of the flow rate allows identification of a more specific location where the failure has occurred, for example, identification of whether the failure is clogging of the water flow channel, a failure of the pump, or the like.

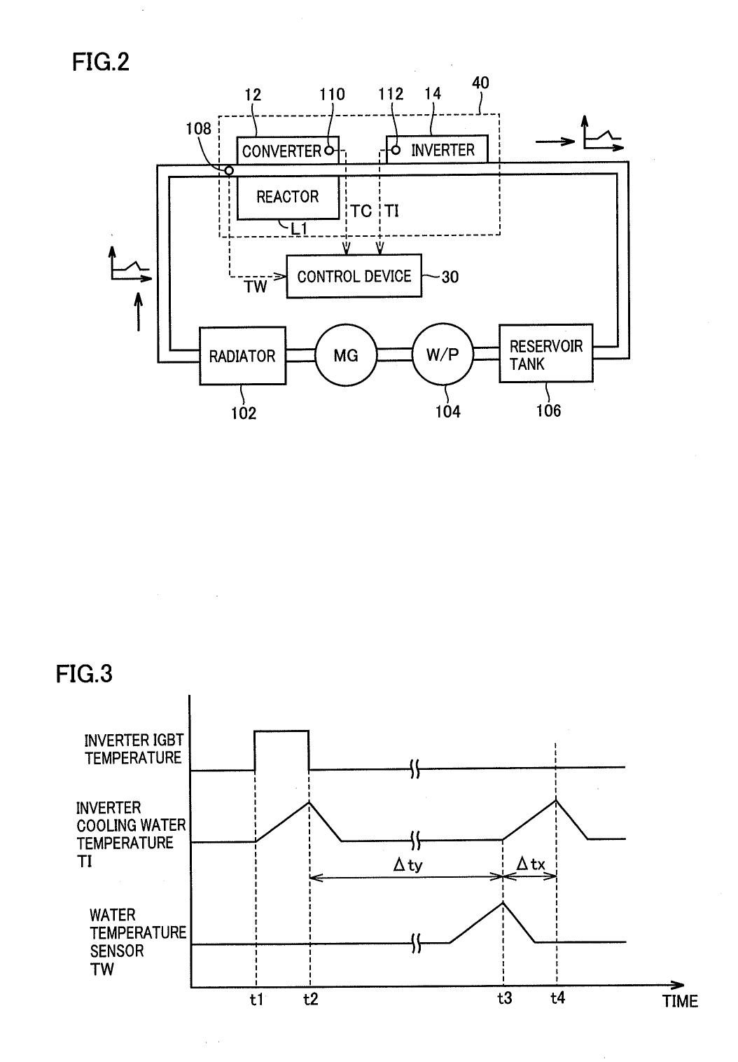

FIG. 2 is a diagram for illustrating a principle of flow rate estimation in the present embodiment.

FIG. 2 shows a configuration of the cooling mechanism extracted from the configuration of vehicle 100 in FIG. 1. Radiator 102, PCU 40, reservoir tank 106, water pump 104, and motor generator MG are annularly connected in series by the water flow channel. Water pump 104 circulates the cooling water in the direction indicated by arrows shown in the drawing.

In the vicinity of the cooling water inlet of PCU 40, temperature sensor 108 which measures the cooling water temperature is provided. Cooling water temperature TW is transmitted from temperature sensor 108 to control device 30. Further, in PCU 40, temperature sensor 110 which detects temperature TC of voltage converter 12 and temperature sensor 112 which detects temperature TI of inverter 14 are provided. As temperature sensors 110, 112 each, a temperature detection element or the like embedded in an intelligent power module is used.

FIG. 3 is an operation waveform diagram for illustrating control related to the flow rate estimation.

Referring to FIGS. 2 and 3, if the operation state of the vehicle permits, control device 30 controls converter 12 or inverter 14 to temporarily increase a heat generating amount in converter 12 or inverter 14. FIG. 3 shows a case where the temperature of the IGBTs included in inverter 14 rises in a pulsed manner.

Then, temperature TI of the cooling water passing through inverter 14 rises in a period when the heat generated by the IGBTs is increased (t1 to t2), and thereafter lowers to the original temperature. The cooling water heated in a pulsed manner is forced out of PCU 40 into the water flow channel at a speed corresponding to a flow rate of the pump.

The cooling water heated in a pulsed manner will be hereinafter referred to as a “thermal pulse”. The thermal pulse passes through reservoir tank 106, water pump 104, motor generator MG, and radiator 102, and reaches temperature sensor 108 at a time t3 and is detected. Then, the thermal pulse is also detected by the temperature sensor for inverter 14 at a time t4.

A time Δtx for which the thermal pulse propagates in PCU 40 from temperature sensor 108 to temperature sensor 112 for inverter 14, or a time Δty for which the thermal pulse propagates through the entire cooling mechanism from temperature sensor 112 to temperature sensor 108 is used to determine a flow speed and a flow rate.

Since a distance between the temperature sensors is constant, control device 30 can determine the flow speed when it detects propagation time Δty or Δtx of the thermal pulse. Further, since the flow rate is obtained by multiplying the flow speed by a flow channel sectional area, and the flow channel sectional area is also constant, control device 30 can also determine the flow rate when propagation time Δty or Δtx is determined. It is noted that the relationship between the propagation time of the thermal pulse and the flow rate may be experimentally determined and mapped in advance.

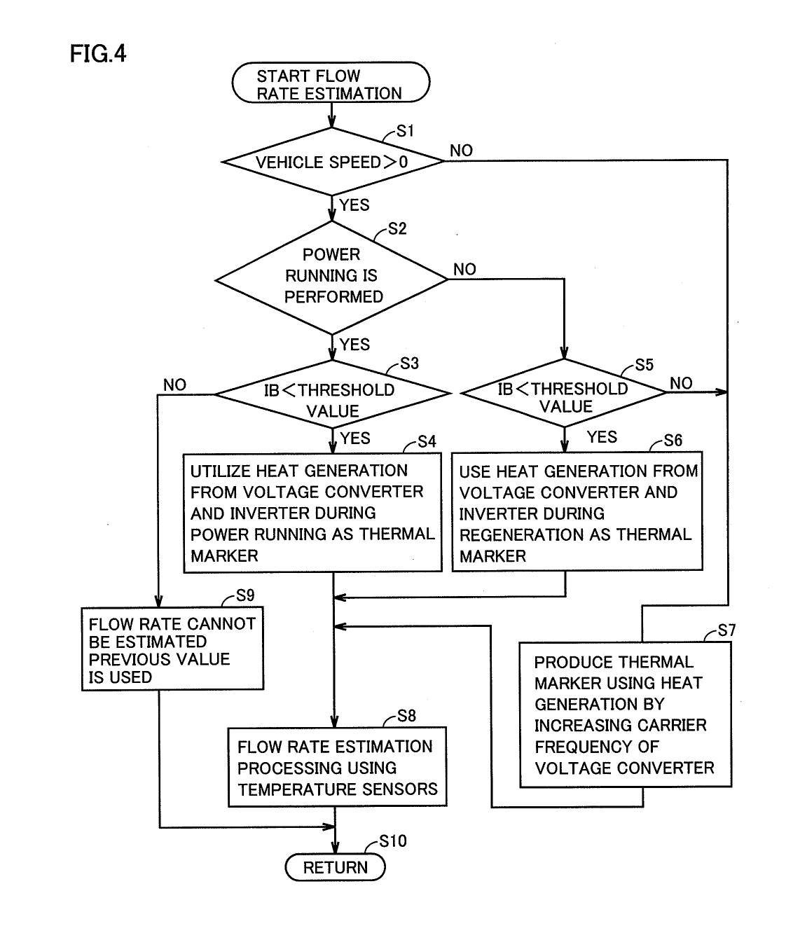

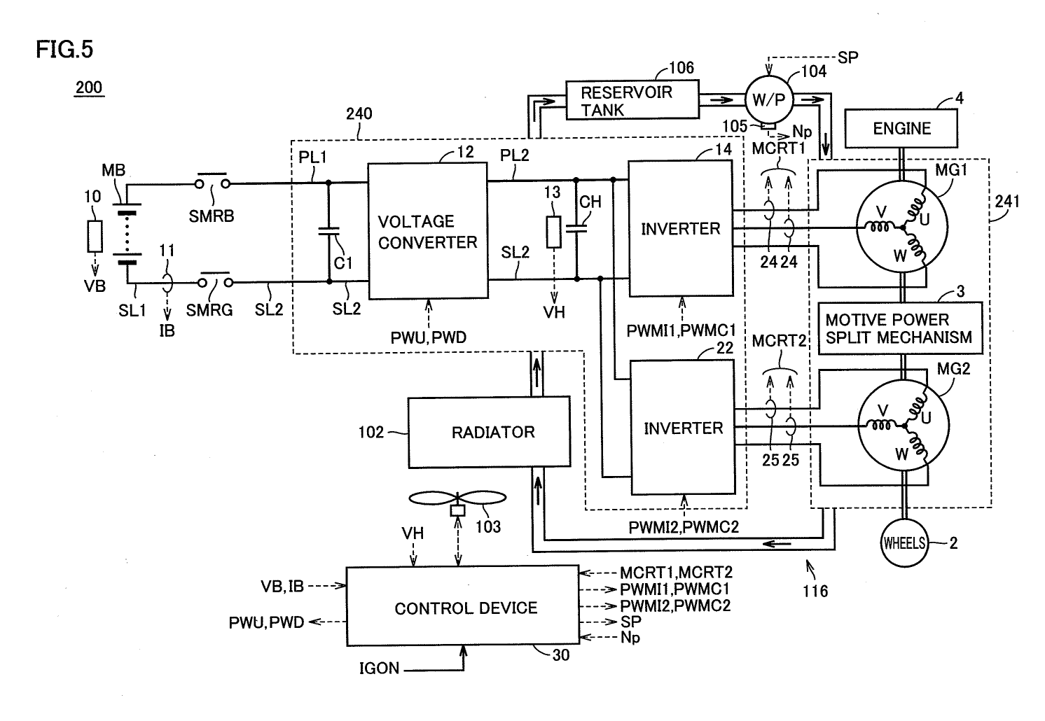

FIG. 4 is a flowchart for illustrating flow rate estimation processing executed in Embodiment 1. The processing in this flowchart is called from a main routine and executed at regular time intervals or whenever a predetermined condition is satisfied.

Referring to FIGS. 1 and 4, firstly in step S1, control device 30 determines whether or not a vehicle speed is greater than 0. The vehicle speed can be obtained from an output of a wheel speed sensor, a resolver which detects the rotation speed of motor generator MG, or the like, although they are not shown in FIG. 1.

If the vehicle speed is greater than 0 in step S1, the processing proceeds to step S2. In contrast, if the vehicle speed is 0 or negative in step S1, the processing proceeds to step S7.

In step S2 where the vehicle is running, it is determined whether or not a power running operation is performed. For example, when the vehicle is running up a slope or accelerating on a flat road, motor generator MG of vehicle 100 performs a power running operation. In contrast, when the vehicle is slowing down by a user depressing a brake pedal or the like, regenerative braking is used and motor generator MG performs a regenerative operation.

If motor generator MG performs the power running operation in step S2, the processing proceeds to step S3. If motor generator MG does not perform the power running operation in step S2, the processing proceeds to step S5.

In step S3, it is determined whether or not current IB of battery MB is smaller than a threshold value. The threshold value is determined to correspond to an upper limit value of a current that can be output from battery MB. If IB<threshold value is not satisfied in step S3, there is no more room to cause voltage converter 12 or inverter 14 to generate heat to increase current IB, and thus the processing proceeds to step S9. In step S9, since it is not possible to perform flow rate estimation processing at this point, the latest estimated flow rate value that has been previously estimated and obtained is directly used as a present estimated flow rate value.

In contrast, if the processing proceeds from step S3 to step S4, voltage converter 12 or inverter 14 is caused to generate heat to produce a thermal marker. As the thermal marker, a thermal pulse may be generated as shown in FIG. 3, for example by increasing a carrier frequency. Alternatively, when an operation causing a sudden change in temperature is performed as a driving operation, it may be utilized as a thermal marker. Examples of such an operation include a sudden acceleration operation performed by depressing an accelerator pedal.

If it is determined in step S2 that motor generator MG does not perform power running, the processing proceeds to step S5. In step S5, it is determined whether or not the magnitude of current IB of battery MB is smaller than a threshold value. The threshold value is determined to correspond to an upper limit value of a current that can be input to battery MB.

If |IB|<threshold value is satisfied in step S5, the processing proceeds to step S6. In step S6, for example, a time point at which a brake pedal is depressed, generation of a regenerative current is started, and heat generation from the inverter or the converter is increased is used as a thermal marker. This heat change is transferred to the cooling water, and the flow rate can be determined based on a time lag taken for the heat change to be reflected in the plurality of temperature sensors.

If |IB|<threshold value is not satisfied in step S5, there is no more room to increase the regenerative current from voltage converter 12 or inverter 14, and thus the processing proceeds to step S7.

In step S7, by increasing the carrier frequency of voltage converter 12, the heat generating amount of the IGBT elements in voltage converter 12 is increased to thereby produce a thermal marker. When the carrier frequency of voltage converter 12 is increased, a thermal marker can be produced even when the vehicle is stopped or the vehicle is slowing down by operating a brake, although current IB of the battery is increased.

When a thermal marker is produced by the processing in any of steps S4, S6, and S7, by detecting a time lag required for the thermal marker to move with any two of temperature sensors 108, 110, and 112, a moving speed and the flow rate can be determined from a map, a calculation formula, or the like.

As described above, in Embodiment 1, the flow rate can be estimated without using an expensive flow rate sensor. The estimated flow rate can be used to identify a location of an abnormality in the cooling mechanism, to perform feedback control on an output of the water pump, and the like.

This can avoid the water pump from being replaced without necessity when a failure occurs in the cooling mechanism. Further, power consumption in the water pump can be reduced by detecting the flow rate and controlling the water pump to have an appropriate flow rate.

### Embodiment 2

Embodiment 1 has described the technique for estimating the flow rate of the cooling water in the electric vehicle. Embodiment 2 will describe a technique for estimating a flow rate of cooling water in a hybrid vehicle. In the hybrid vehicle, if a battery can be charged when the vehicle is stopped or is running, a thermal marker can be produced by charging the battery using an engine and a generator. Thus, the hybrid vehicle has a degree of freedom for producing a thermal marker higher than that of the electric vehicle.

FIG. 5 is a circuit diagram showing a configuration of a vehicle 200 mounted with a cooling system for the vehicle.

Referring to FIG. 5, vehicle 200 includes battery MB which is a power storage device, voltage sensor 10, a power control unit (PCU) 240, a drive unit 241, an engine 4, wheels 2, and control device 30. Drive unit 241 includes motor generators MG1, MG2, and a motive power split mechanism 3.

PCU 40 includes voltage converter 12, smoothing capacitors C1, CH, voltage sensor 13, and inverters 14, 22. Vehicle 100 further includes positive bus PL2 for supplying electric power to inverter 14 which drives motor generator MG. Drive unit 241 includes motor generators MG1, MG2, and motive power split mechanism 3.

Voltage converter 12 is a voltage conversion device provided between battery MB and positive bus PL2 for performing voltage conversion. Smoothing capacitor C1 is connected between positive bus PL1 and negative bus SL2. Voltage converter 12 boosts a voltage between the terminals of smoothing capacitor C1. Since voltage converter 12 has a circuit configuration identical to that of voltage converter 12 described in FIG. 1, the description of the circuit configuration will not be repeated.

Smoothing capacitor CH smoothes the voltage boosted by voltage converter 12. Voltage sensor 13 detects voltage VH between the terminals of smoothing capacitor CH and outputs detected voltage VH to control device 30.

Inverter 14 converts a DC voltage supplied from voltage converter 12 into a three-phase AC voltage and outputs it to motor generator MG1. Inverter 22 converts the DC voltage supplied from voltage converter 12 into a three-phase AC voltage and outputs it to motor generator MG2. Since inverters 14 and 22 have a circuit configuration identical to that of inverter 14 described in FIG. 1, the description of the circuit configuration will not be repeated.

Motive power split mechanism 3 is a mechanism which is coupled to engine 4 and motor generators MG1, MG2 to split motive power among them. As the motive power split mechanism, for example, a planetary gear mechanism having three rotation shafts of a sun gear, a planetary carrier, and a ring gear can be used. In the planetary gear mechanism, when rotations of two of the three rotation shafts are determined, rotation of the other one rotation shaft is inevitably determined. These three rotation shafts are connected to rotation shafts of engine 4 and motor generators MG1, MG2, respectively. It is noted that the rotation shaft of motor generator MG2 is coupled to wheels 2 by means of a reduction gear and a differential gear not shown. Further, a reducer for the rotation shaft of motor generator MG2 may be further incorporated into motive power split mechanism 3.

Vehicle 200 further includes system main relay SMRB connected between the positive terminal of battery MB and positive bus PL1, and system main relay SMRG connected between the negative terminal of battery MB (negative bus SL1) and node N2.

The conductive/nonconductive state of system main relays SMRB, SMRG is controlled in response to a control signal provided from control device 30.

Voltage sensor 10 measures voltage VB between the terminals of battery MB. A current sensor 11 which detects current IB flowing in battery MB is provided to monitor the state of charge of battery MB together with voltage sensor 10. As battery MB, for example, a secondary battery such as lead-acid battery, nickel-metal hydride battery, or lithium ion battery, or a large-capacity capacitor such as electric double-layer capacitor can be used.

Inverter 14 is connected to positive bus PL2 and negative bus SL2. Inverter 14 receives the boosted voltage from voltage converter 12, and drives motor generator MG1 to start engine 4, for example. Further, inverter 14 returns electric power generated by motor generator MG1 using motive power transferred from engine 4, to voltage converter 12. At this time, voltage converter 12 is controlled by control device 30 to operate as a buck circuit.

Current sensor 24 detects a current flowing in motor generator MG1 as a motor current value MCRT1, and outputs motor current value MCRT1 to control device 30.

Inverter 22 is connected to positive bus PL2 and negative bus SL2 in parallel with inverter 14. Inverter 22 converts the DC voltage output from voltage converter 12 into a three-phase AC voltage and outputs it to motor generator MG2 which drives wheels 2. Further, when regenerative braking is performed, inverter 22 returns electric power generated by motor generator MG2 to voltage converter 12. At this time, voltage converter 12 is controlled by control device 30 to operate as a buck circuit. Current sensor 25 detects a current flowing in motor generator MG2 as a motor current value MCRT2, and outputs motor current value MCRT2 to control device 30.

Control device 30 receives each torque command value and rotation speed of motor generators MG1, MG2, respective values of current IB and voltages VB, VH, motor current values MCRT1, MCRT2, and activation signal IGON. Control device 30 outputs, to voltage converter 12, control signal PWU for giving an instruction to boost the voltage, control signal PWD for giving an instruction to buck the voltage, and a shutdown signal for giving an instruction to inhibit operation.

Further, control device 30 outputs, to inverter 14, a control signal PWMI1 for giving a drive instruction to convert the DC voltage which is an output from voltage converter 12 into an AC voltage for driving motor generator MG1, and a control signal PWMC1 for giving a regeneration instruction to convert an AC voltage generated by motor generator MG1 into a DC voltage and return the DC voltage to voltage converter 12.

Similarly, control device 30 outputs, to inverter 22, a control signal PWMI2 for giving a drive instruction to convert the DC voltage into an AC voltage for driving motor generator MG2, and a control signal PWMC2 for giving a regeneration instruction to convert an AC voltage generated by motor generator MG2 into a DC voltage and return the DC voltage to voltage converter 12.

[Description of Cooling Mechanism in Embodiment 2]

Vehicle 200 includes, as a cooling mechanism for cooling PCU 240 and drive unit 241, radiator 102, reservoir tank 106, and water pump 104.

Radiator 102, PCU 240, reservoir tank 106, water pump 104, and drive unit 241 are annularly connected in series by water flow channel 116.

Water pump 104 is a pump for circulating cooling water such as an antifreeze liquid, and circulates the cooling water in a direction indicated by arrows shown in the drawing. Radiator 102 receives, from the water flow channel, the cooling water having cooled voltage converter 12 and inverter 14 in PCU 240, and cools the received cooling water.

It is noted that, although not shown, temperature sensor 108 which measures a cooling water temperature, temperature sensor 110 which detects temperature TC of voltage converter 12, and temperature sensor 112 which detects temperature TI of inverter 14 described in FIG. 2 are also provided in the configuration of FIG. 5.

Control device 30 generates signal SP for driving water pump 104 based on outputs of the temperature sensors, and outputs generated signal SP to water pump 104.

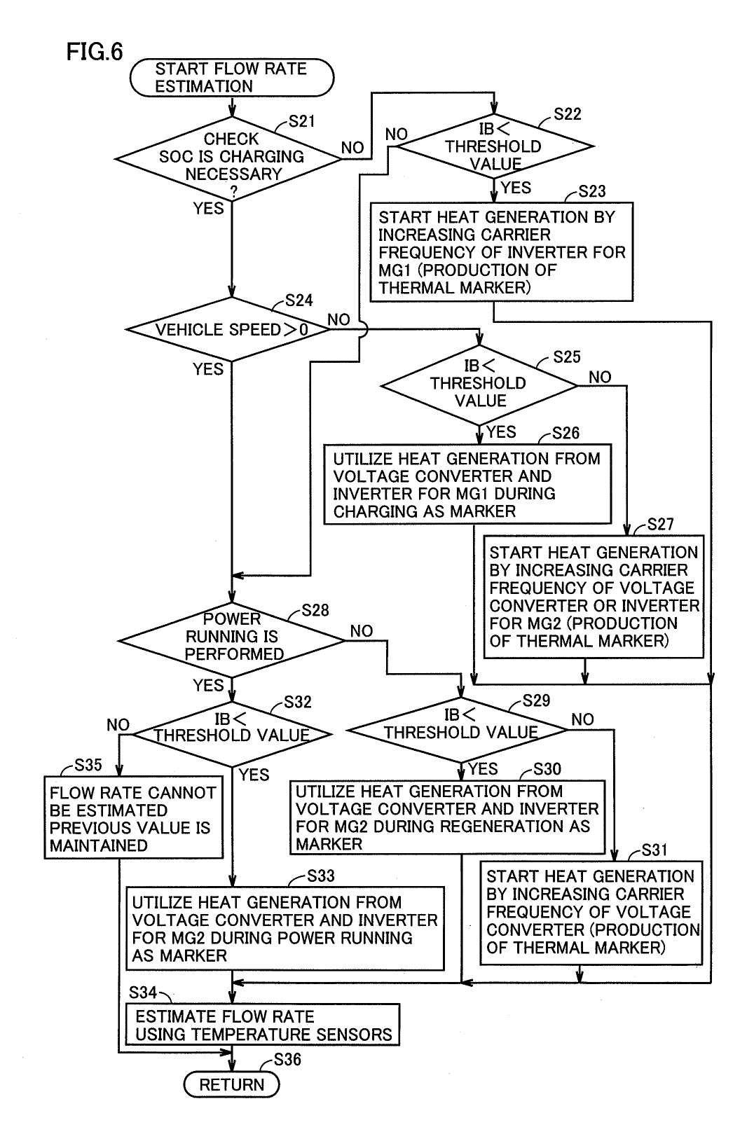

FIG. 6 is a flowchart for illustrating flow rate estimation processing executed in Embodiment 2. The processing in this flowchart is called from a main routine and executed at regular time intervals or whenever a predetermined condition is satisfied.

Referring to FIGS. 5 and 6, firstly in step S1, control device 30 checks the state of charge (SOC) of battery MB, and determines whether or not battery MB should be charged. The situation where the battery should be charged means that the SOC is lower than a predetermined threshold value. The predetermined threshold value can be arbitrarily set between a management lower limit value and a management upper limit value of the SOC of the battery. It is noted that the predetermined threshold value may be a threshold value for determining whether or not the battery is not fully charged and can accept charging power.

If it is determined in step S21 that battery MB does not have to be charged, the processing proceeds to step S22. In step S22, it is determined whether or not current IB of the battery is smaller than a threshold value. In a situation where the battery does not have to be charged, if current IB of the battery is smaller than the threshold value, battery MB may be overcharged when motor generator MG1 is rotated by engine 4 to generate electric power. Thus, if it is determined in step S22 that current IB of the battery is smaller than the threshold value, the processing proceeds to step S23. In step S23, by increasing the carrier frequency of inverter 14 for motor generator MG1, the IGBT elements in inverter 14 are caused to generate heat to produce a thermal marker. When the carrier frequency is increased, inverter 14 can generate heat without an increase in electric power generated by motor generator MG1.

In contrast, if current IB of the battery is not smaller than the threshold value in step S22, the processing proceeds to step S28.

If it is determined in step S21 that the battery should be charged, the processing proceeds to step S24. In step S24, control device 30 determines whether or not a vehicle speed is greater than 0. The vehicle speed can be obtained from an output of a wheel speed sensor, a resolver which detects the rotation speed of motor generator MG2, or the like, although they are not shown in FIG. 5.

If the vehicle speed is greater than 0 in step S24, the processing proceeds to step S28. In contrast, if the vehicle speed is 0 or negative in step S24, the processing proceeds to step S25.

In step S25, it is determined whether or not the magnitude of current IB of battery MB is smaller than a threshold value. The threshold value is determined to correspond to an upper limit value of a current that can be charged into battery MB. Here, when a direction in which current IB is discharged from battery MB is assumed as positive, current IB has a negative value when charging occurs. Since step S25 means that the magnitude of a charging current determines whether or not there is room in the upper limit value, it is only necessary in this case to determine whether or not the absolute value of current IB exceeds the threshold value.

If |IB|<threshold value is satisfied in step S25, the processing proceeds to step S26. In step S26, heat generation from voltage converter 12 and inverter 14 for MG1 during charging is utilized as a thermal marker. For example, a time point at which motor generator MG1 is rotated by the engine to start power generation when production of a thermal marker is desired, and thereby generation of the charging current is started, and heat generation from the inverter or the converter is increased is used as a thermal marker. This heat change is transferred to the cooling water, and the flow rate can be determined based on a time lag taken for the heat change to be reflected in the plurality of temperature sensors.

If |IB|<threshold value is not satisfied in step S25, there is no more room to increase the charging current from voltage converter 12 or inverter 22, and thus the processing proceeds to step S27.

In step S27, by increasing the carrier frequency of voltage converter 12 or inverter 22 for MG2, the heat generating amount of the IGBT elements is increased to thereby produce a thermal marker. When the carrier frequency of voltage converter 12 is increased, a thermal marker can be produced even when the vehicle is stopped, although current IB of the battery is increased. Further, when the carrier frequency of inverter 22 is increased, a thermal marker can be produced relatively freely even when MG1 is generating electric power.

The case where the processing proceeds from step S22 or step S24 to step S28 will be described. In step S28 where the vehicle is running, it is determined whether or not a power running operation is performed. For example, when the vehicle is running up a slope or accelerating on a flat road, motor generator MG2 of vehicle 200 performs a power running operation. In contrast, when the vehicle is slowing down by a user depressing a brake pedal or the like, regenerative braking is used and motor generator MG2 performs a regenerative operation.

If motor generator MG2 performs the power running operation in step S28, the processing proceeds to step S32. If motor generator MG2 does not perform the power running operation in step S28, the processing proceeds to step S29.

In step S32, it is determined whether or not current IB of battery MB is smaller than a threshold value. The threshold value is determined to correspond to an upper limit value of a current that can be output from battery MB. If IB<threshold value is not satisfied in step S32, there is no more room to cause voltage converter 12 or inverters 14, 22 to generate heat to increase current IB, and thus the processing proceeds to step S35. In step S35, since it is not possible to perform flow rate estimation processing at this point, the latest estimated flow rate value that has been previously estimated and obtained is directly used as a present estimated flow rate value.

In contrast, if the processing proceeds from step S32 to step S33, voltage converter 12 or inverter 22 for MG2 during power running is caused to generate heat to produce a thermal marker. As the thermal marker, a thermal pulse may be generated as shown in FIG. 3, for example by increasing a carrier frequency. Alternatively, when an operation causing a sudden change in temperature is performed as a driving operation, it may be utilized as a thermal marker. Examples of such an operation include a sudden acceleration operation performed by depressing an accelerator pedal.

If it is determined in step S28 that motor generator MG2 does not perform power running, the processing proceeds to step S29. In step S29, it is determined whether or not the magnitude of current IB of battery MB is smaller than a threshold value. The threshold value is determined to correspond to an upper limit value of a current that can be input to battery MB.

Here, when a direction in which current IB is discharged from battery MB is assumed as positive, current IB has a negative value when charging occurs. Since step S25 means that the magnitude of a charging current generated by regeneration determines whether or not there is room in the upper limit value, it is only necessary in this case to determine whether or not the absolute value of current IB exceeds the threshold value.

If |IB|<threshold value is satisfied in step S29, the processing proceeds to step S30. In step S30, heat generation from voltage converter 12 and inverter 22 for MG2 during regeneration is utilized as a thermal marker. For example, a time point at which a brake pedal is depressed, generation of a regenerative current is started, and heat generation from the inverter or the converter is increased is used as a thermal marker. This heat change is transferred to the cooling water, and the flow rate can be determined based on a time lag taken for the heat change to be reflected in the plurality of temperature sensors.

If |IB|<threshold value is not satisfied in step S29, there is no more room to increase the regenerative current from voltage converter 12 or inverter 22, and thus the processing proceeds to step S31.

In step S31, by increasing the carrier frequency of voltage converter 12, the heat generating amount of the IGBT elements in voltage converter 12 is increased to thereby produce a thermal marker. When the carrier frequency of voltage converter 12 is increased, a thermal marker can be produced even when the vehicle is stopped or the vehicle is slowing down by operating a brake, although current IB of the battery is increased.

When a thermal marker is produced by the processing in any of steps S23, S26, S27, S30, and S31, by detecting a time lag required for the thermal marker to move with two temperature sensors, a moving speed and the flow rate can be determined from a map, a calculation formula, or the like.

In Embodiment 2, the flow rate can be estimated in the hybrid vehicle, and can be used to analyze a failure in the cooling mechanism and improve accuracy of controlling the water pump.

It is noted that, as the thermal marker for measuring the flow rate, data obtained while the vehicle is running can be directly used. For example, a change in heat generation which occurs when an operation of charging battery MB by MG1 is started immediately after the vehicle is activated, when a load is increased at the time of sudden acceleration, or the like can be used as a thermal marker.

Further, the thermal marker can be actively produced by control. For example, when the carrier frequency of the inverter or the voltage converter is increased, the heat generating amount the embedded IGBT elements is increased. In addition, when the carrier frequency of the voltage converter is decreased to be lower than a predetermined value, a ripple current is increased and reactor L1 generates heat. This may be used as a thermal marker.

Further, as the temperature sensor used to detect the marker, a water temperature sensor, a temperature sensor embedded in a voltage converter or an inverter, a temperature sensor for a reactor, and the like can be used. When a DC/DC converter is cooled by a cooling mechanism, a temperature sensor for the DC/DC converter may be used.

It should be understood that the embodiments disclosed herein are illustrative and non-restrictive in every respect. The scope of the present invention is defined by the scope of the claims, rather than the description above, and is intended to include any modifications within the scope and meaning equivalent to the scope of the claims.

### REFERENCE SIGNS LIST

2: wheel; 3: motive power split mechanism; 4: engine; 10, 13: voltage sensor; 11, 24, 25: current sensor; 12: voltage converter; 14, 22: inverter; 15: U phase arm; 16: V phase arm; 17: W phase arm; 22: inverter; 30: control device; 100, 200: vehicle; 102: radiator; 103: radiator fan; 104: water pump; 106: reservoir tank; 108, 110, 112: temperature sensor; 116: water flow channel; 241: drive unit; C1, CH: smoothing capacitor; D1 to D8: diode; L1: reactor; MB: battery; MG, MG1, MG2: motor generator; PL1, PL2: positive bus; Q1 to Q8: IGBT element; SL1, SL2: negative bus; SMRB, SMRG: system main relay.

1. A cooling system for a vehicle, comprising:
a flow channel circulating a liquid medium cooling a drive device of the vehicle;
a plurality of temperature sensors provided at different positions on said flow channel;
a heating element provided on said flow channel and cooled by said liquid medium; and
a control device controlling heat generation from said heating element,
said control device changing a heat generating state of said heating element, and estimating a flow rate of said liquid medium flowing through said flow channel based on a time lag taken for detecting a temperature change caused by changing said heat generating state by said plurality of temperature sensors.

2. The cooling system for the vehicle according to claim 1, wherein
said drive device includes
a motor, and
a power control unit for driving said motor, and
said heating element is a power control element in said power control unit.

3. The cooling system for the vehicle according to claim 2, wherein, in a case where the vehicle is stopped, said control device changes a drive state of said power control element to change said heat generating state when said control device estimates said flow rate, such that no drive torque is generated at wheels.

4. The cooling system for the vehicle according to claim 3, wherein
said vehicle includes a power storage device supplying electric power to said motor,
said power control unit includes
a voltage converter converting a voltage of said power storage device, and
an inverter supplying and receiving electric power to and from said power storage device via said voltage converter, and driving said motor, and
said control device changes a heat generating amount of said power control element by changing a carrier frequency of said voltage converter.

5. The cooling system for the vehicle according to claim 3, wherein
said vehicle includes
an internal combustion engine,
a generator rotated by said internal combustion engine, and
a power storage device charged by said generator and supplying electric power to said motor,
said power control unit includes
a voltage converter converting a voltage of said power storage device, and
an inverter receiving electric power generated by said generator, and supplying and receiving electric power to and from said power storage device via said voltage converter, and
said control device changes a heat generating amount of said power control element by causing said generator to generate electric power and causing said power storage device to be charged.

6. The cooling system for the vehicle according to claim 2, wherein, in a case where the vehicle is running, said control device estimates said flow rate when a drive state of said power control element is changed and a change in said heat generating state occurs.

7. The cooling system for the vehicle according to claim 2, further comprising a pump provided on said flow channel for circulating said liquid medium,
wherein said control device controls driving of said pump based on the estimated flow rate of said liquid medium.

8. The cooling system for the vehicle according to claim 2, further comprising a pump provided on said flow channel for circulating said liquid medium, and a water flow channel,
wherein said control device identifies whether said pump or said water flow channel has a failure, based on a rotation speed of the pump and the estimated flow rate of said liquid medium.
